(19) United States
(12) Patent Application Publication
(10) Pub. No.: US 2025/0043114 A1
(43) Pub. Date: Feb. 6, 2025

(54) COMPOSITION OF ELASTOMERIC COMPOSITE CONTAINING AN OXIDE FILLER FOR APPLICATIONS IN SUBSTRATES AND INSULATING LAYERS OF FLEXIBLE ANTENNAS

(71) Applicant: The Research Center for Advanced Materials Science King Khalid University (KKU), Abha (SA)

(72) Inventors: Abdullah G. AL-SEHEMI, Abha (SA); Ahmed A. AL-GHAMDI, Jeddah (SA); Nikolay Todorov DISHOVSKY, Sofia (BG); Nikolay Todorov ATANASOV, Sofia (BG); Gabriela Lachezarova ATANASOVA, Sofia (BG); Irena Kirilova MIHAYLOVA, Sofia (BG); Petrunka Atanasova MALINOVA, Sofia (BG); Lychezar Nikolaev Radev, Sofia (BG)

(73) Assignee: The Research Center for Advanced Materials Science, King Khalid University (KKU), Abha (SA)

(21) Appl. No.: 18/363,199

(22) Filed: Aug. 1, 2023

(51) Int. Cl. C08L 7/00; C08K 3/06; C08K 3/22; C08K 3/36; C08K 5/09; C08K 5/44

(52) U.S. Cl. CPC C08L 7/00; C08K 3/06; C08K 3/22; C08K 3/36; C08K 5/09; C08K 5/44; C08K 2003/2296; C08K 2201/014; C08L 2203/20

(57) ABSTRACT

An elastomeric composite containing an oxide filler, the elastomeric composite will find application in the preparation of substrates and insulating layers for flexible antennas. The composition of the elastomeric composite is based on natural rubber and contains an oxide filler which is calcium silicate phosphate CaO—SiO₂—P₂O₅ in the amount of 25 to 75 parts by mass per 100 parts by mass of rubber, and the other ingredients are zinc oxide, stearic acid, tertiary butyl-benzothiazolyl sulphenamide and sulphur in the following amounts—zinc oxide from 3 to 5, stearic acid from 1 to 3, tertiary butyl-benzothiazolyl sulphenamide from 0.6 to 1 and sulphur from 2 to 3, whereas the amount of the components in the oxide filler CaO—SiO₂—P₂O₅ are the following (in wt. %): CaO—63.70, P₂O₅—5.97, SiO₂—30.33

### FIELD

This invention relates to an elastomeric composite containing an oxide filler, which will find application in the preparation of substrates and insulating layers for flexible antennas.

### BACKGROUND

The document EN 112723 A is known, which relates to an elastomeric composition, encapsulating a compact antenna based on natural rubber. The composition according to the invention is based on natural rubber, and the components in the composition are in parts by mass per 100 parts by mass of natural rubber (phr), the components being: glass-ceramic filler, which is acermanite or mervinite-35-65; zinc oxide-3; stearic acid—2; polymerized trimethyl dihydroquinoline-1.5; tertiary butyl-benzothiazolyl-sulfenamide-1.5; sulphur-2. The known composition does not provide a sufficiently low dielectric loss angle tangent of the composite.

Another document U.S. Pat. No. 5,557,286 A has disclosed a composition of a dielectric ceramic having application in the fabrication of antenna structures. An improved dielectric powder was created containing barium strontium titanate BST, prepared by a sol-gel method. Graphite was added to the resulting dielectric powder, resulting in a highly porous BST substrate, where the included graphite is burned off. A low dielectric filler is added to the thermally treated substrate to provide a composite substrate of physical hardness. The filler may be organic or inorganic, such as epoxy resin or low-loss oxide powder. The composition according to the invention relates to a dielectric ceramic, which does not possess the necessary flexibility and elasticity, and could not be applied in the manufacture of substrates for flexible antennas.

The article of “L. Radev, Influence of thermal treatment on the structure and in vitro bioactivity of sol-gel prepared CaO—SiO₂—P₂O₅ glass-ceramics, Processing and Application of Ceramics, 8 (2014) 3, 155-166” describes the synthesis and bioactive properties of a series of samples prepared at different temperatures up to 1,500° C. of CaO—SiO₂—P₂O₅-based material. The resulting sol-gel glass-ceramic is biocompatible and is used in the preparation of joint prostheses.

Document CN103086703A discloses a ceramic material containing a multi-component oxide filler that possesses a relatively low dielectric loss angle tangent, but it lacks sufficient flexibility and ductility, and thus could not be used in elastic substrates for flexible antennas.

### SUMMARY

The objective of this invention is to create a composition of an elastomeric composite containing an oxide filler and for the composite to have a low dielectric loss angle tangent, high flexibility and elasticity, which ensures its use in the substrates of flexible antennas.

Such objective is achieved by an elastomeric composite composition according to the invention based on natural rubber containing an oxide filler, which is calcium silicate phosphate CaO—SiO₂—P₂O₅ in the amount of 25 to 75 parts by mass per 100 parts by mass of rubber (phr) and the remaining ingredients are zinc oxide, stearic acid, tertiary butyl benzothiazolyl sulfenamide and sulphur in the following amounts: zinc oxide—from 3 to 5, stearic acid—from 1 to 3; tertiary butyl benzothiazolyl sulfenamide—from 0.6 to 1 and sulphur—from 2 to 3.

The amount of components of the oxide filler CaO—SiO₂—P₂O₅ are (in wt %): CaO—63.70. P₂O₅—5.97, SiO₂—30.33.

The CaO—SiO₂—P₂O₅ oxide filler was synthesized by a multistep sol-gel method, which includes the following operations: preparation of sol A by mixing suitable amounts of Ca(OH)₂ and SiO₂; preparation of sol B containing two components of Ca(OH)₂ and H₃PO₄; mixing the two sols, and the resulting mixed sol is gelled at 120° C. for 12 hours and treated thermally at 1,200° C. Three crystal phases are obtained:
Calcium silicate (larnite) β-Ca₂SiO₄;
Calcium silicate pseudolastonite CaSiO₃;
Calcium silicate phosphate Ca₁₅ (PO₄)₂(SiO₄)₆;
   The filler is synthesized in powder form, which is not monolithic and sintered, thus ensuring its better dispersibility in the elastomer composite.
   The filler has the following chemical composition:

| | | Quantity, |
|---|---|---|
| Seq. No. | Oxide | %ₘₐₛₛ |
| 1 | Calcium oxide/CaO | 63.70 |
| 2 | Phosphorus, as in P₂O₅ | 5.97 |
| 3 | Silicon dioxide/SiO₂ | 30.33 |

The synthesized sample has the following phase composition, confirmed by the XRD-analysis and FTIR-spectroscopy:
Calcium silicate (larnite) β-Ca₂SiO₄
Calcium silicate (Pseudo-lastonite) CaSiO₃
Calcium silicate phosphate Ca₁₅(PO₄)₂(SiO₄)₆
   The filler composition must also comprise an amorphous phase with a calcium silicate phosphate composition.

To date, there is no known elastomeric composite with filler based on a three-component oxide mixture of CaO—SiO₂—P₂O₅. Surprisingly, it was found that the elastomeric composite containing the filler has the required low dielectric loss angle tangent due to the incorporation of the filler according to the invention and in addition the composite has high flexibility and elasticity, which ensures its use in the substrates for flexible antennas.

The incorporation of CaO—SiO₂—P₂O₅ as a filler in elastomer composites used as substrates in flexible antennas provides enhanced performance, guarantees a lower dielectric loss angle tangent of the composite material compared to known solutions. Due to its lower dielectric losses, the elastomer composite offers flexibility and elasticity that ceramics do not have.

### DETAILED DESCRIPTION

The preferred example embodiments illustrate the invention without limiting it

According to the invention, the filler based on CaO—SiO₂—P₂O₅ has the following physical and chemical properties:

Chemical composition of the filler:

| Sequence | | Quantity, |
|---|---|---|
| No. | Oxide | %ₘₐₛₛ |
| 1 | Calcium oxide/CaO | 63.70 |
| 2 | Phosphorus as P₂O₅ | 5.97 |
| 3 | Silica/SiO₂ | 30.33 |

The phase composition was confirmed by XRD-analysis and FTIR-spectroscopy of the synthesized sample, which was as follows:
Calcium silicate (larnite) β-Ca2SiO4
Calcium silicate (Pseudolastonite) CaSiO3
Calcium silicate phosphate Ca₁₅(PO₄)₂(SiO₄)₆
   Tests have been made on elastomeric composites designated as: NR-0 (without filler), NR-25 (with filler at 25 phr fill), NR-50 (with filler at 50 phr fill) and NR-75 (with filler at 75 phr fill), and the vulcanization characteristics, physical and mechanical indicators and dielectric characteristics of the composites were analyzed.

### Vulcanization Characteristics of Elastomer Composites at 160° C.

| | NR - 0 | NR - 25 | NR - 50 | NR - 75 |
|---|---|---|---|---|
| CaO—SiO₂—P₂O₅, phr | 0 | 25 | 50 | 75 |
| ML, dN · m | 0.04 | 0.03 | 0.06 | 0.09 |
| MH, dN · m | 4.92 | 5.63 | 7.44 | 9.00 |
| ΔM, dN · m | 4.88 | 5.60 | 7.38 | 8.91 |
| ts1, min:s | 2.04 | 1.54 | 1.44 | 1.30 |
| ts2, min:s | 2.25 | 2.10 | 1.54 | 1.38 |
| t50, min:s | 2.36 | 2.25 | 2.14 | 1.58 |
| t90, min:s | 4.11 | 3.51 | 3.31 | 3.07 |

### Physical and Mechanical Indicators of Elastomer Composites

| | NR - 0 | NR - 25 | NR - 50 | NR - 75 |
|---|---|---|---|---|
| CaO—SiO₂—P₂O₅, phr | 0 | 25 | 50 | 75 |
| M100, MPa | 0.5 | 0.6 | 0.8 | 0.9 |
| M300, MPa | 1.4 | 1.7 | 1.9 | 2.0 |
| σ, MPa | 18.6 | 18.3 | 16.5 | 14.0 |
| εᵣₑₗ, % | 685 | 675 | 685 | 670 |
| εᵣₑₛ, % | 12 | 17 | 22 | 25 |
| ShA | 38 | 41 | 46 | 49 |

Dielectric Characteristics of the Studied Composites at Frequency of f=2.56 GHz

| | ε′ | ε″ | σ, S/m | tanδ_{ε} |
|---|---|---|---|---|
| NR-0 | 2.58547 | 0.0099 | 0.001412 | 0.003811 |
| NR-25 | 2.796951 | 0.009771 | 0.001394 | 0.003492 |
| NR-50 | 2.897328 | 0.007925 | 0.00113 | 0.002734 |
| NR-75 | 3.345431 | 0.00735 | 0.001048 | 0.002197 |

ε′—actual (real) part of the complex dielectric permeability
ε″—imaginary part of the complex dielectric permeability
σ, S/m, electrical conductivity
tanδ_{ε}—dielectric loss angle tangent

According to the aforementioned indicators, NR-75 is the most suitable for incorporation into elastomeric composites as it possesses the lowest value of the dielectric loss angle tangent, and the composites were tested at a frequency of 2.56 GHz.
From the studies conducted on the filler properties based on CaO—SiO₂—P₂O₅, a composition of elastomer composites for embedding in flexible antennas was developed including the following components:

### Example 1

Composition of elastomeric composites (in phr parts by mass per 100 parts by mass of rubber):
1. Natural rubber TSR 10—100
2. Zinc oxide—3
3. Stearic acid—1
4. TBBS (Tertiary butyl benzothiazolyl sulfenamide) vulcanisation accelerator—0.6
5. Sulphur—vulcanising agent—3
6. Filler—Calcium silicate phosphate—CaO—SiO₂—P₂O₅—25
   The production of the rubber mixture is carried out in an open laboratory two rolls mill in the following sequence of operations and process mode:

Initially, the rubber is plasticized. At the fourth minute of plasticizing, zinc oxide and stearic acid are added. After a three-minute homogenization, i.e. on the seventh minute, half the amount of filler is added. After another three-minute homogenization, respectively at the tenth minute, the second half of the filler is added. Next, the mixture is homogenized again and at the sixteenth minute the vulcanization accelerator (TBBS) and sulphur are added. The mixture is again homogenized for four minutes and at the twentieth minute the rubber mixture is now ready and removed from the mixer.

### Example 2

Composition of elastomeric composites (in phr parts by mass per 100 parts by mass of rubber):
1. Natural rubber TSR 10—100
2. Zinc oxide—5
3. Stearic acid—3
4. TBBS (Tertiary butyl benzothiazolyl sulfenamide) vulcanisation accelerator—1
5. Sulphur—vulcanising agent—2
6. Filler—Calcium Silicate Phosphate—CaO—SiO₂—P₂O₅—50

Making the rubber compound in a sequence of operations and process mode, as in Example 1.

### Example 3

Composition of elastomeric composites (in parts by mass per 100 parts by mass of rubber):
1. Natural rubber TSR 10—100
2. Zinc oxide—5
3. Stearic acid—2
4. TBBS (Tertiary butyl benzothiazolyl sulfenamide) vulcanisation accelerator—0.8
5. Sulphur—vulcanising agent—2.25
6. Filler—Calcium Silicate Phosphate—CaO—SiO₂—P₂O₅—75
Making the rubber compound in a sequence of operations and process mode, as in Example 1.
   The advantages of this invention are due to the incorporation of the filler-calcium silicate phosphate CaO—SiO₂—P₂O₅ in amounts of 25, 50 and 75 parts by mass in the elastomeric composite, thanks to which the resulting product has sufficient flexibility and elasticity. This is evidenced by the vulcanization characteristics, physical and mechanical indicators and dielectric characteristics of the elastomer composites described above. In addition, the filler according to the invention provides a lower dielectric loss angle tangent of the composite, resulting in better performance of the elastomeric composites used in the substrates and insulating layers of flexible antennas.

1. A composition of an elastomeric composite based on natural rubber, containing an oxide filler and ingredients, wherein, the oxide filler—calcium silicate phosphate CaO—SiO₂—P₂O₅ in the amounts of 25 to 75 parts by mass per 100 parts by mass rubber and the ingredients-zinc oxide, stearic acid, tertiary butyl-benzothiazolyl sulphenamide and sulphur in the following amounts—zinc oxide from 3 to 5, stearic acid from 1 to 3, tertiary butyl-benzothiazolyl sulphenamide from 0.6 to 1 and sulphur from 2 to 3.

2. The composition of an elastomeric composite based on natural rubber according to claim 1, wherein the amount of the components of the oxide filler—CaO—SiO₂—P₂O₅ are as follows (in wt. %): CaO—63.70, P₂O₅—5.97, SiO₂—30.33.
